(19) United States
(12) Patent Application Publication
(10) Pub. No.: US 2026/0111063 A1
(43) Pub. Date: Apr. 23, 2026

(54) ENERGY ESTIMATION SYSTEM AND METHOD FOR OPENBMC-BASED FIRMWARE STACKS

(71) Applicant: Dell Products L.P., Round Rock, TX (US)

(72) Inventors: Chih-Wen Huang, Taipei (TW); Chun-Hung Yu, Zhubei (TW)

(73) Assignee: Dell Products L.P., Round Rock, TX (US)

(21) Appl. No.: 18/932,894

(22) Filed: Oct. 31, 2024

(30) Foreign Application Priority Data
Oct. 23, 2024 (CN) 2024-11481823.0

(51) Int. Cl. G06F 1/20; G06F 1/3296

(52) U.S. Cl. CPC G06F 1/206; G06F 1/3296

(57) ABSTRACT

Embodiments of the present disclosure provide an energy estimation system and method for openBMC-based firmware stacks that empirically determines a power loading offset value that may be applied to a BMC executing an openBMC-based firmware stack to make an IHS run more efficiently. According to one embodiment, an Information Handling System (IHS) includes a Baseboard Management Controller (BMC) that includes firmware to when an openBMC-based firmware stack is executed on the BMC, apply a power loading offset value to adjust a speed of one or more fans configured on the target IHS, and when a standard firmware stack is executed on the BMC, apply a power loading offset value to adjust the speed of the fans without applying the power loading offset value.

### CROSS-REFERENCE TO RELATED APPLICATIONS

This application claims the benefit of the filing date of, Chinese Patent Application No. 2024-11481823.0, filed on Oct. 23, 2024, titled “ENERGY ESTIMATION SYSTEM AND METHOD FOR OPENBMC-BASED FIRMWARE STACKS,” the disclosure of which is hereby incorporated by reference herein in its entirety.

### BACKGROUND

As the value and use of information continues to increase, individuals and businesses seek additional ways to process and store information. One option available to users are Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Modern day IHS administrative management is often provided via Baseboard Management Controllers (BMCs) also referred to as Remote Access Controllers (RACs). The BMC generally includes a specialized microcontroller embedded in the IHS, and may provide an interface between system-management software and platform hardware. Different types of sensors built into the IHS report to the BMC on parameters such as temperature, cooling fan speeds, power status, operating system (O/S) status, and the like. The BMC monitors the sensors and can send alerts to a system administrator via the network if any of the parameters do not stay within pre-set limits, indicating a potential failure of the system. The administrator can also remotely communicate with the BMC to take certain corrective actions, such as resetting or power cycling the system to get a hung O/S running again. These abilities can often save on the total cost of ownership of an IHS, particularly when implemented in large clusters, such as server farms.

### SUMMARY

Embodiments of the present disclosure provide an energy estimation system and method for openBMC-based firmware stacks that empirically determines a power loading offset value that may be applied to a BMC executing an openBMC-based firmware stack to make an IHS run more efficiently. According to one embodiment, an Information Handling System (IHS) includes a Baseboard Management Controller (BMC) that includes firmware to when an openBMC-based firmware stack is executed on the BMC, apply a power loading offset value to adjust a speed of one or more fans configured on the target IHS, and when a standard firmware stack is executed on the BMC, apply a power loading offset value to adjust the speed of the fans without applying the power loading offset value.

According to another embodiment, an energy estimation method for an openBMC-based firmware stack includes the steps of applying a power loading offset value to adjust a speed of one or more fans configured on an Information Handling System (IHS) associated with the BMC when the openBMC-based firmware stack is executed on the Baseboard Management Controller (BMC), and when a standard firmware stack is executed on the BMC, applying a power loading offset value to adjust the speed of the fans without applying the power loading offset value.

According to yet another embodiment, a Baseboard Management Controller (BMC) includes executable code to apply a power loading offset value to adjust a speed of one or more fans configured on an Information Handling System (IHS) associated with the BMC when the openBMC-based firmware stack is executed on the Baseboard Management Controller (BMC), and when a standard firmware stack is executed on the BMC, apply a power loading offset value to adjust the speed of the fans without applying the power loading offset value.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIG. 1 is a block diagram of examples of components of an Information Handling System (IHS), according to one embodiment of the present disclosure.

FIG. 2A illustrates a spreadsheet window of a spreadsheet that is used to determine offset values for IHSs that are managed by an openBMC-based firmware stack according to one embodiment of the present disclosure.

FIG. 2B illustrates an example table showing how the power loading offset values may be obtained according to one embodiment of the present disclosure.

FIG. 3 illustrates an example openBMC-based firmware stack energy estimation method that may be performed to adjust a speed of one or more fans in an IHS according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Certain IHSs may be configured with BMCs that are used to monitor, and in some cases manage computer hardware components of their respective IHSs. A BMC is normally programmed using a firmware stack that configures the BMC for performing out-of-band (e.g., external to a computer's operating system or BIOS) hardware management tasks. The BMC firmware can support industry-standard specifications, such as the Intelligent Platform Management Interface (IPMI) and Systems Management Architecture of Server Hardware (SMASH) for computer system administration.

The BMC firmware is normally proprietary and is often developed by the vendor and shipped along with the BMC to the end user. Nevertheless, industry trends have migrated toward custom BMC firmware stacks (e.g., operating systems) that allow the end user greater control over how the BMC operates. OpenBMC is one example standard under which openBMC-based firmware stacks may be generated. In general, openBMC is a collaborative open-source Linux distribution for BMCs meant to work across heterogeneous systems that include enterprise, high-performance computing (HPC), telecommunications, and cloud-scale data centers.

While openBMC-based firmware stacks, such as those implemented according to openBMC standards, may provide enhanced manageability, transparency, and customization, its implementation has not been without drawbacks. For example, standard BMC firmware stacks are often implemented by the vendor of the IHS in which the BMC is deployed and therefore, the quality and reliability of the BMC's functionality can be controlled to a relatively good degree. One example of such a standard BMC firmware stack is the iDRAC firmware stack provided by the DELL TECHNOLOGIES. On the other hand, openBMC-based firmware stacks, which are typically developed in uncontrolled environments, often possess relatively higher levels of software faults (e.g., bugs). One particular type of firmware stack is an Open Server Manager (OSM) that is built on the openBMC standard, and provided by DELL TECHNOLOGIES.

Due to certain software feature limitations of openBMC-based stacks, they do not have access to certain thermal sensors that would otherwise be required in order to provide proper cooling for the IHS. For example, most openBMC-based firmware stacks do not have access to thermal sensors on cards configured on a PCIe card slot. Most standard firmware stacks do not have this issue on thermal sensor utilization, and thus can support different modes of operation (e.g., system idle mode, maximum loading, etc.) with a properly calibrated fan table.

The workaround of platform thermal design is to increase the fan speed proportionally during idle mode of the IHS when using openBMC-based firmware stacks. Thus, the openBMC-based firmware stacks will generate more idle power compared to standard firmware stacks. This problem, nevertheless, can be quite dramatic. For example, it is estimated that the difference in energy used by a single IHS server can cost up to fifteen thousand dollars over the serviceable life of the IHS. As will be described in detail herein below, embodiments of the present disclosure provide an energy estimation system and method for openBMC-based firmware stacks that empirically determines a power loading offset value that may be applied to a BMC executing an openBMC-based firmware stack to make an IHS run more efficiently.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, science, control, or other purposes. For example, an IHS may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price.

The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components.

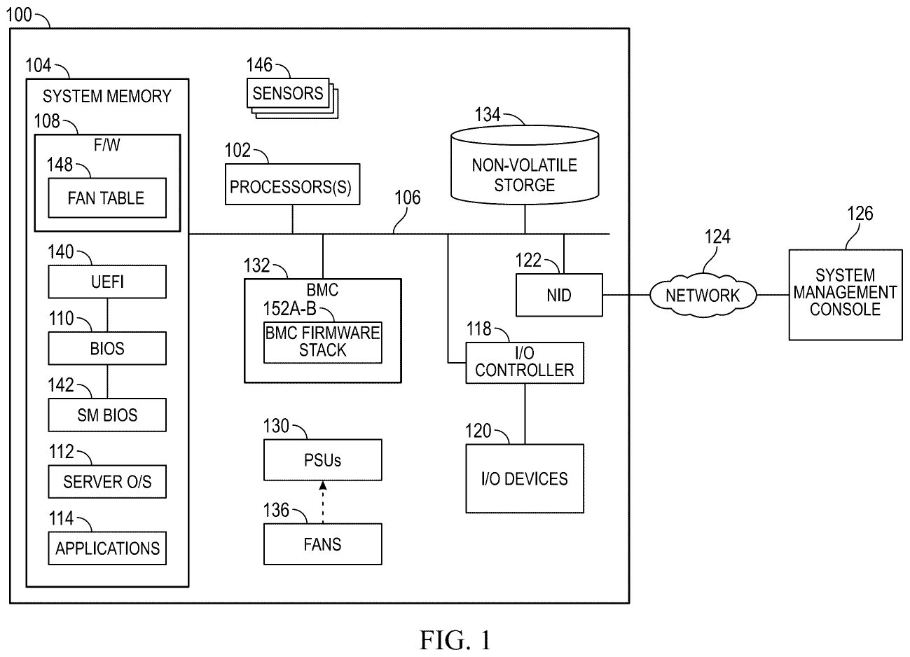

FIG. 1 is a block diagram of examples of components of an Information Handling System (IHS), according to some embodiments. Particularly, IHS 100 includes one or more processor(s) 102 coupled to system memory 104 via system interconnect 106. System interconnect 106 may include any suitable system bus. System memory 104 may include a plurality of software and/or firmware modules including firmware (F/W) 108, basic input/output system (BIOS) 110, operating system (O/S) 112, and/or application(s) 114. Software and/or firmware module(s) stored within system memory 104 may be loaded into processor(s) 102 and executed during operation of IHS 100.

IHS 100 includes one or more input/output (I/O) controllers 118 which manages the operation of one or more connected input/output (I/O) device(s) 120, such as a keyboard, mouse, touch screen, microphone, a monitor or display device, a camera, a microphone, audio speaker(s) (not shown), an optical reader, a universal serial bus (USB), a card reader, Personal Computer Memory Card International Association (PCMCIA) slot, and/or a high-definition multimedia interface (HDMI), which may be included or coupled to IHS 100.

IHS 100 includes Network Interface Device (NID) 122. NID 122 enables IHS 100 to communicate and/or interface with other devices, services, and components that are located externally to IHS 100. These devices, services, and components, such as a system management console 126, can interface with IHS 100 via an external network, such as network 124, which may include a local area network, wide area network, personal area network, the Internet, etc.

System memory 104 may include a UEFI interface 140 and/or a SMBIOS interface 142 for accessing the BIOS as well as updating BIOS 110. In general, UEFI interface 140 provides a software interface between an operating system and BIOS 110. In many cases, UEFI interface 140 can support remote diagnostics and repair of computers, even with no operating system installed. SMBIOS interface 142 can be used to read management information produced by BIOS 110 of an IHS 100. This feature can eliminate the need for the operating system to probe hardware directly to discover what devices are present in the computer.

IHS 100 further includes one or more power supply units (PSUs) 130. PSUs 130 are coupled to a BMC 132 via an I²C bus. BMC 132 enables remote operation control of PSUs 130 and other components within IHS 100. PSUs 130 power the hardware devices of IHS 100 (e.g., processor(s) 102, system memory 104, non-volatile storage 134, NID 122, I/O controllers 118, PSUs 130, etc.). To assist with maintaining temperatures within specifications, an active cooling system, such as one or more fans 136 may be utilized.

IHS 100 further includes one or more sensors 146. Sensors 146 may, for instance, include a thermal sensor that is in thermal communication with certain hardware devices that generate relatively large amounts of heat, such as processors 102 or PSUs 130. Sensors 146 may also include voltage sensors that communicate signals to BMC 132 associated with, for example, an electrical voltage or current at an input line of PSU 130, and/or an electrical voltage or current at an output line of PSU 130.

BMC 132 may be configured to provide out-of-band management facilities for IHS 100. Management operations may be performed by BMC 132 even if IHS 100 is powered off, or powered down to a standby state. BMC 132 may include a processor, memory, and an out-of-band network interface separate from and physically isolated from an in-band network interface of IHS 100, and/or other embedded resources.

In certain embodiments, BMC 132 may include or may be part of a Remote Access Controller (e.g., a DELL Remote Access Controller (DRAC) or an Integrated DRAC (IDRAC)). In other embodiments, BMC 132 may include or may be an integral part of a Chassis Management Controller (CMC).

F/W 108 includes a fan table 148 that is used to store fan speed data for certain hardware devices (e.g., processor(s) 102, system memory 104, non-volatile storage 134, NID 122, I/O controllers 118, etc.). In general, the fan table 148 may be populated with values that indicate a fan speed that is to be used for some, most, or all fans in the IHS 100 when certain conditions are met. According to embodiments of the present disclosure, the values in the fan table 148 may be configured to adjust the fan speed values according to an offset value that represents a measured difference between the power consumed by an IHS 100 that is managed by an openBMC-based firmware stack versus the power consumed by the IHS 100 that is managed by a standard firmware stack. While the fan table 148 is shown stored in the F/W 108 of the IHS 100, it should be appreciated that the fan table 148 may be stored in any suitable storage location, such as in a secure non-volatile memory (NVM) of the IHS 100. Additional details associated with the fan table 148 will be described in detail herein below.

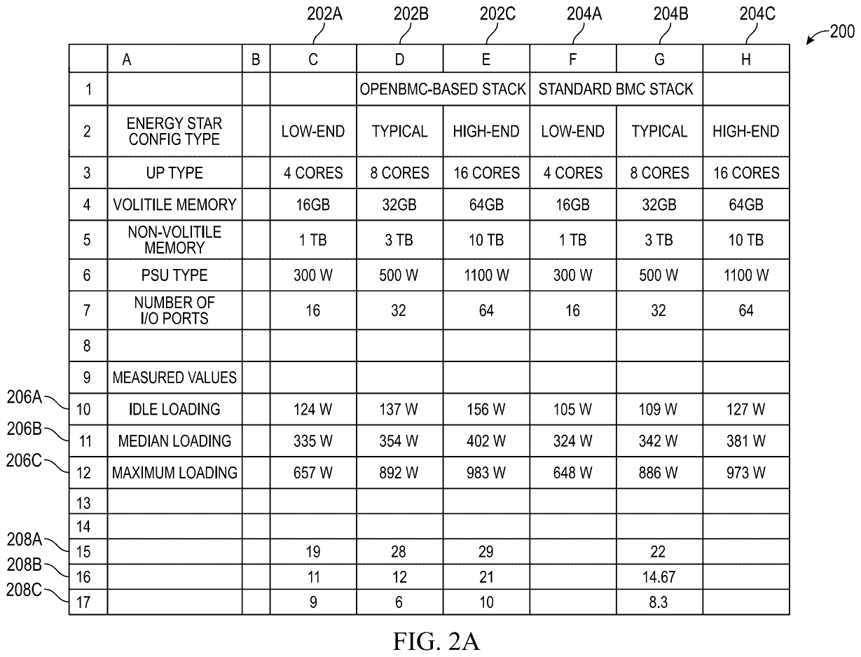

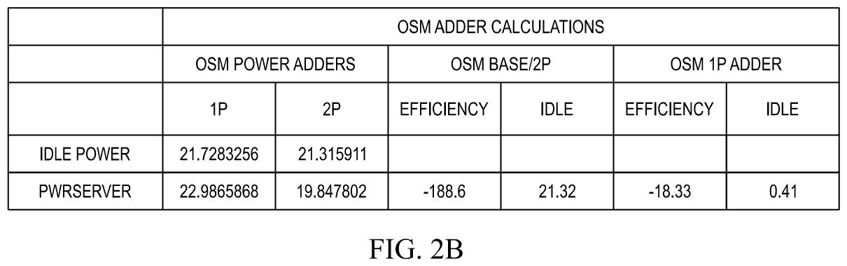

FIG. 2A illustrates a spreadsheet window 200 of a spreadsheet that is used to determine offset values for IHSs that are managed by an openBMC-based firmware stack according to one embodiment of the present disclosure. The spreadsheet window 200 includes three columns 202a-c showing various characteristics of a first, second, and third IHS 100, respectively, that are managed by an openBMC-based firmware stack. In particular, column 202a is associated with an IHS 100 having a low-end ES configuration type, column 202b is associated with an IHS 100 having a typical ES configuration type, and column 202c is associated with an IHS 100 having a high-end ES configuration type. The characteristics include those that may directly affect the amount of power that is used by each IHS 100. As shown, the characteristics may include a type of processor(s) used, an amount of volatile memory configured in each IHS 100, an amount of non-volatile memory configured in each IHS 100, a PSU type used, and a number of external I/O ports configured on the IHS 100.

The spreadsheet window 200 includes three rows 206a-c that indicate the measured power used by the IHS 100 during an idle mode 206a, a median loading mode 206b, and a maximum loading mode 206c. The spreadsheet window 200 also includes three columns 204a-c showing various characteristics of the first, second, and third IHS 100, respectively, that are managed by a standard firmware stack. The spreadsheet window 200 also includes three rows 206a-c that indicate the measured power used by the IHS 100 during an idle mode 206a, a median loading mode 206b, and a maximum loading mode 206c.

For each of the differing types (e.g., low-end, median, high-end) of IHSs 100, a power usage offset may be obtained that indicates the difference in power used by the IHS 100 when managed by an openBMC-based firmware stack versus a standard firmware stack. For example, rows 208a-c shows offset values for each low-end, median, and high-end IHS 100 at an idle state, a median loading state, and a maximum loading state, respectively. In particular, cell C15 indicates a power usage offset for the low-end IHS 100 at the idle state, while cell E17 indicates the power usage offset for the high-end IHS 100 at the maximum loading state. It should be important to note that the servers used in the spreadsheet window 200 are one processor servers, and that measurements should also be performed in a similar manner for two processor servers.

In one embodiment, an average power usage offset may be calculated for each power loading level (e.g., idle state, median loading state, maximum loading state) measured by the system. For example, cell G15 indicates an average power loading offset for each of the low-end, median, and high-end IHSs 100 at the idle level, Cell G16 indicates an average power loading offset for each of the low-end, median, and high-end IHSs 100 at the median loading state, and cell G17 indicates an average power loading offset for each of the low-end, median, and high-end IHSs 100 at the maximum loading state.

In one embodiment, the power loading offset values may be calculated according to a Standard Performance Evaluation Corporation (SPEC) standard. According to the spec standard, Lot9 active efficiency requirements specify that two processor servers (IHSs) should have an efficiency ratio of at least 9.5. As such, the efficiency of a server with two processors running with an openBMC-based firmware stack 152b may be related to its power usage according to equation 1:

$${OSMEFF}_{{base}_{2 P}} = - 9.5 * {Pwrserver}_{2 P} \qquad Equation 1$$

Where OSMEFF_{base2p} is the efficiency of a server managed by an openBMC-based firmware stack, and Pwrserver_{2P} is the actual amount of power used by that server. Additionally, idle power consumed by the server may be set according to equation 2:

$${OSMIdle}_{{base}_{2 P}} = {IdlePower}_{2 P} \qquad Equation 2$$

Where OSMIdle_{base2P} is the 21.315911, and IdlePower_{2P} is 21.32.

According to the spec standard, Lot9 active efficiency requirements specify that one processor servers (IHSs) should have an efficiency ratio of at least 9. As such, the efficiency of a server with one processor running with an openBMC-based firmware stack 152b may be related to its power usage according to equation 3:

$${OSMEFF}_{1 Pdelta} = - 9 * {Pwrserver}_{1 P} - {OSMEFF}_{{base}_{2 P}} \qquad Equation 3$$

Where OSMEFF_{1Pdelta} is the is the performance of a server managed by an openBMC-based firmware stack 152b, and Pwrserver_{1P} is the amount of power used by that server, and OSMEFF_{base2P} is −188.6. Additionally, the difference in idle power used by a two processor server and a one processor server may be determined according to equation 4:

$${OSMIdle}_{1 Pdelta} = {IdlePower}_{1 P} - {IdlePower}_{2 P} \qquad Equation 4$$

Where IdlePower_{1P} is the idle power used by a one processor server, and IdlePower_{2P} is the idle power used by a two processor server.

FIG. 2B illustrates an example table showing how power loading offset values may be obtained from equations 1˜4 according to one embodiment of the present disclosure. As shown, the difference at idle power is relatively small and thus, no power loading offset values are used. The power loading offset values, however, at normal usage for a two processor server is −188.6 Watts, and 21.32 Watts at idle, and for a one processor server is −18.33 Watt at normal usage, 0.41 Watts difference at idle. It should be appreciated that the power loading offset values are calculated for servers managed by an OSM openBMC-based firmware stack, and that different power loading offset values can be obtained when other firmware stacks conforming to the openBMC standard are used.

In one embodiment, the average power usage offsets may be stored in the fan table 148 such that, when the standard firmware stack 152a is being used, the values in the fan table 148 will be used to set the speed of the fan(s) 136 without using the power loading offset values, and when the openBMC-based firmware stack 152b is being used, the values in the fan table 148 will be used to set the speed of the fan(s) 136 by using the power loading offset values. Thus in this manner, the power loading offset values may be used to accurately set the speed of the fan(s) 136 without necessarily needing to have access to all of the thermal sensors configured in the IHS 100, such as when the openBMC-based firmware stack 152b is not capable of accessing the thermal sensors through a PCIe bus.

In some embodiments, only one or a few power loading offset values may be used. For example, the average power usage loading level at the idle state is shown to be 22 Watts, while the average power usage loading levels at the median loading state and the maximum loading state is shown to be 9.1 Watts and 4.3 Watts, respectively. Accordingly, only the average power usage loading value at the idle state will be used to provide a fan speed adjustment.

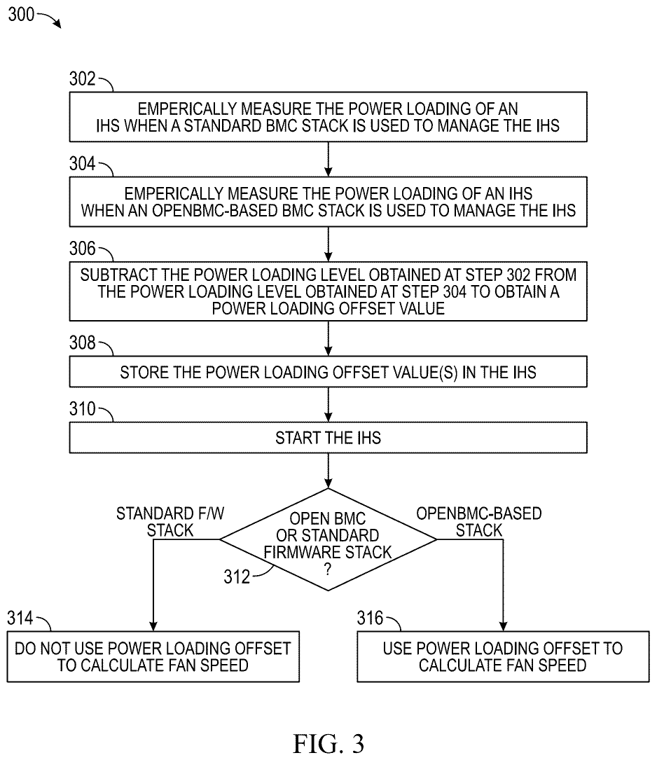

FIG. 3 illustrates an example openBMC-based firmware stack energy estimation method 300 that may be performed to adjust a speed of one or more fans in an IHS 100 according to one embodiment of the present disclosure. In one embodiment, the method 300 may be performed in whole, or at least in part, by either of a standard firmware stack 152a or an openBMC-based firmware stack 152b that is loaded on and executed by the BMC 132.

Initially at step 302, the power loading level of an IHS 100 is empirically measured when a standard firmware stack 152a is used to manage the IHS 100. In one embodiment, multiple power loading levels may be empirically measured at different power states (e.g., an idle state, a median loading state, a maximum loading state, etc.). In another embodiment, the power loading levels for different IHS configurations (e.g., low-end, typical, high-end, etc.) may be empirically obtained. At step 304, the power loading level(s) of an IHS 100 is empirically measured when an openBMC-based firmware stack 152a is used to manage the IHS 100.

The method 300 then uses the measured power loading values to obtain a power loading offset value at step 306. In one embodiment, the method 300 may obtain multiple power loading offset values for different power loading levels that the IHS 100 may incur. In another embodiment, the method 300 may obtain multiple power loading offset values for different IHS configurations (e.g., low-end, typical, high-end, etc.) and average the multiple power loading values to obtain an average power loading value. In yet another embodiment, the method 300 may obtain the power loading offset values using a Standard Performance Evaluation Corporation (SPEC) standard minimum efficiency ratio.

At step 308, the method 300 stores the power loading offset value(s) in a target IHS 100. In one embodiment, the power loading offset value(s) may be stored in a fan table 148. In another embodiment, the fan table 148 may be stored in a secure memory location within the target IHS 100. The target IHS 100 is then started at step 310.

The method 300 then determines whether a standard firmware stack or openBMC-based firmware stack is being used to manage the operation of the target IHS 100. For example, either of a standard firmware stack 152a or an openBMC-based firmware stack 152b loaded on the BMC 132 may be included with information (e.g., hard-coded) to know whether it is a standard firmware stack 152a or an openBMC-based firmware stack 152b. If the BMC 132 is loaded with a standard firmware stack 152a, processing continues at step 314 in which the power loading offset value is not used to set the speed of any fan(s) 136 in the target IHS 100. If, however, the BMC 132 is loaded with an openBMC-based firmware stack 152b, processing continues at step 316 in which the power loading offset value is used to set or otherwise adjust the speed of the fan(s) 136 in the target IHS 100. Either of steps 314 or 316 are continually performed during the operation of the target IHS 100, or until the target IHS 100 is turned off. When the target IHS 100 is again started (e.g., re-booted), steps 310-316 may again be performed to properly adjust the speed of the fan(s) for enhancing the efficiency of the target IHS 100.

Although FIG. 3 describes one example of a method that may be performed for adjusting the speed of the fan(s) 136 in a target IHS 100 when an openBMC-based firmware stack 152b is loaded on a BMC 132, the features of the disclosed process may be embodied in other specific forms without deviating from the spirit and scope of the present disclosure. For example, the method 300 may perform additional, fewer, or different operations than those operations as described in the present example. As another example, certain steps of the aforedescribed process may be performed by other components of the BMC 132 and/or target IHS 100, such as by a controller chip configured on the BMC 132, or by the BIOS 110 executed on the target IHS 100.

It should be understood that various operations described herein may be implemented in software or software modules executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements that such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A target Information Handling System (IHS), comprising:
a Baseboard Management Controller (BMC) that manages the operation of the IHS, the BMC comprising one or more processors and one or more memory units including instructions that, upon execution by the processors, cause the BMC to:
when an openBMC-based firmware stack is executed on the BMC, apply a power loading offset value to adjust a speed of one or more fans configured on the target IHS; and
when a standard firmware stack is executed on the BMC, apply a power loading offset value to adjust the speed of the fans without applying the power loading offset value.

2. The IHS of claim 1, wherein the instructions further cause the BMC to apply one of a plurality of the power loading offset values based upon a current power load of the target IHS.

3. The IHS of claim 1, wherein the power loading offset value is obtained using a Standard Performance Evaluation Corporation (SPEC) standard minimum efficiency ratio.

4. The IHS of claim 1, wherein the power loading offset value is obtained by averaging a power loading of a plurality of different IHS configurations.

5. The IHS of claim 1, wherein the wherein the power load offset value is stored in a fan table.

6. The IHS of claim 5, wherein the fan table is stored in a secure memory of the target IHS.

7. The IHS of claim 1, wherein the power loading offset value is obtained by empirically measuring a test IHS at different load levels.

8. An energy estimation method for an openBMC-based firmware stack, the method comprising:
when the openBMC-based firmware stack is executed on the Baseboard Management Controller (BMC), applying a power loading offset value to adjust a speed of one or more fans configured on an Information Handling System (IHS) associated with the BMC; and
when a standard firmware stack is executed on the BMC, applying a power loading offset value to adjust the speed of the fans without applying the power loading offset value.

9. The method of claim 8, further comprising applying one of a plurality of the power loading offset values based upon a current power load of the target IHS.

10. The method of claim 8, further comprising obtaining the power loading offset value using a Standard Performance Evaluation Corporation (SPEC) standard minimum efficiency ratio.

11. The method of claim 8, further comprising obtaining the power loading offset value by averaging a power loading of a plurality of different IHS configurations.

12. The method of claim 8, further comprising storing the power load offset value in a fan table.

13. The method of claim 12, further comprising storing the fan table in a secure memory of the target IHS.

14. The method of claim 8, further comprising obtaining the power loading offset value by empirically measuring a test IHS at different load levels.

15. A Baseboard Management Controller (BMC), comprising:
one or more processors and one or more memory units including instructions that, upon execution by the processors, cause the BMC to:
when an openBMC-based firmware stack is executed on the BMC, apply a power loading offset value to adjust a speed of one or more fans configured on a target Information Handling System (IHS) associated with the BMC; and
when a standard firmware stack is executed on the BMC, apply a power loading offset value to adjust the speed of the fans without applying the power loading offset value.

16. The BMC of claim 15, wherein the instructions further cause the BMC to apply one of a plurality of the power loading offset values based upon a current power load of the target IHS.

17. The BMC of claim 15, wherein the power loading offset value is obtained by averaging a power loading of a plurality of different IHS configurations.

18. The BMC of claim 15, wherein the wherein the power load offset value is stored in a fan table.

19. The BMC of claim 18, wherein the fan table is stored in a secure memory of the target IHS.

20. The BMC of claim 15, wherein the power loading offset value is obtained by empirically measuring a test IHS at different load levels.
